(19) United States
(12) Patent Application Publication
(10) Pub. No.: US 2006/0113285 A1
(43) Pub. Date: Jun. 1, 2006

(54) Methods of laser ablating polymeric materials to provide uniform laser ablated features therein

(75) Inventors: Colin G. Maher, Georgetown, KY (US); Bruce H. Ostermeier, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/000,871

(22) Filed: Dec. 1, 2004

(51) Int. Cl. B23K 26/38; B41J 2/14; B41J 2/16

(52) U.S. Cl. 219/121.71; 347/47

(57) ABSTRACT

Improved methods and apparatus for laser ablating polymeric materials. The method includes providing a first mark for laser ablating features in the polymeric material using a laser beam. A second mask is disposed in the laser beam for attenuating laser beam. The polymeric material is laser ablated using the first mask and the second mask in combination so that ablated features made in the polymeric material have substantially uniform feature dimensions.

### FIELD OF THE DISCLOSURE

The disclosure relates to improved methods of laser ablating polymeric materials, and in particular to a method of laser ablating polymeric materials to provide materials having uniform laser ablated features therein from one end of the materials to a second end of the materials.

### BACKGROUND AND SUMMARY

Excimer lasers are widely used in industry to form minuscule structures or ablated features in objects due to their high-energy output and precision. Frequently, a mask is employed in the laser ablation process so that very complex structures may be ablated in the materials. For example, excimer lasers have found a place in the manufacture of nozzle plates for micro-fluid ejection heads, e.g., ink jet printheads. When manufacturing a nozzle plate for a micro-fluid ejection head, it is necessary to form precise nozzle holes in a polymeric material. In some micro-fluid ejection heads, fluid chambers and fluid channels corresponding to the nozzle holes are also ablated in the polymeric material. The quality of the micro-fluid ejection head is affected by the precision with which the polymeric material is ablated by the excimer laser ablation system.

The trend for a number of years for micro-fluid ejection devices is to increase the number of nozzle holes in a nozzle plate while decreasing the fluid droplet size. As the droplet size is decreased, the diameter of the nozzle hole is correspondingly decreased. Accordingly, a small variation in nozzle diameter from one end of a nozzle array to a center portion of the nozzle plate or to another end of the nozzle plate has a greater affect on small diameter nozzles than it does on large diameter nozzles.

Nozzle diameter variations may arise because of anomalies in the manufacturing of lens and optical delivery systems used in the laser system which may result in an inconsistent energy output throughout a width and length of the laser beam. In such a system, the laser beam exhibits a characteristic energy distribution along the beam profile that may result in exit nozzle hole diameter variations from an end to a middle of a nozzle plate along a y-axis of the nozzle plate as illustrated by curve A in FIG. 1. A profile of the laser beam energy distribution as a function of position along the y-axis of the nozzle plate would look similar to the curve A. In fact, it is this laser energy profile that causes the diameter profile. Other factors that may be affected by laser beam energy variations include nozzle hole and ablated feature wall angles and ablated feature depth.

Variations in the ablated features affect the performance of the a micro-fluid ejection head. For example, variations in fluid channel size and fluid chamber dimensions may affect fluid refill times which have a direct impact on a drop mass of fluid ejected and a velocity at which the fluid is ejected. Accordingly, there is a need for improved methods of laser ablating polymeric materials to reduce nozzle hole and flow feature dimension variations from one end of the ablated material to a second end of the ablated material.

With regard to the foregoing, one embodiment of the disclosure provides improved methods and apparatus for laser ablating polymeric materials. The method includes providing a first mask for laser ablating features in the polymeric material using a laser beam. A second mask is disposed adjacent the first mask for attenuating laser beam. The polymeric material is laser ablated using the first mask and the second mask in combination so that ablated features made in the polymeric material have substantially uniform feature dimensions.

In another embodiment, the disclosure provides a laser beam attenuation method for a laser ablation process. The method includes providing a first mask containing ablation features therein for ablating a polymeric material. A second mask is disposed adjacent the first mask. The second mask contains opacity gradation features therein. During the laser ablation process, the second mask is moved relative to the first mask in the laser beam to provide substantially uniform laser beam energy distribution to the first mask so that ablated features in the polymeric material are substantially uniform from a first end of the material to a second end of the material.

An advantage of the methods described herein can include the ability to compensate for laser beam energy variations that affect ablated features in an ablated substrate such as a polymeric material used for a nozzle plate. Laser beam energy compensation may be achieved regardless of whether variations in the laser beam energy are caused by poorly aligned optics, aging optics or interactions between the laser beam and byproducts or plumes emanating from the ablated material during the ablation process.

### BRIEF DESCRIPTION OF THE DRAWINGS

Further advantages of the embodiments will become apparent by reference to the detailed description of exemplary embodiments when considered in conjunction with the drawings, wherein like reference characters designate like or similar elements throughout the several drawings as follows:

FIG. 1 is a two-dimensional graph of nozzle diameter versus y-axis position of a nozzle on a nozzle plate made by a prior art process;

FIG. 2 is a schematic view of a laser ablation system for ablating substrates according to a prior art process;

FIG. 3 is a cross-sectional view, not to scale, of a portion of a micro-fluid ejection head;

FIG. 4 is a perspective view, not to scale, of a fluid cartridge containing a micro-fluid ejection head made according to the disclosure;

FIG. 5 is a perspective view, not to scale, of a device for activating micro-fluid ejection heads on fluid cartridges according to FIG. 4;

FIG. 6 is a partial plan view, not to scale, of a portion of a nozzle plate containing nozzle holes and a portion of a mask used to make nozzle holes in the nozzle plate;

FIG. 7 is a schematic view of a laser ablation system for ablating substrates according to an embodiment of the disclosure;

FIG. 8 is a perspective view, not to scale, of a first and second mask for laser ablation systems according to the disclosure;

FIG. 9 is a two-dimensional graph of an opacity curve versus nozzle plate y-axis for a laser ablation masking process according to a first embodiment of the disclosure;

FIG. 10 is a two-dimensional graph of opacity curves versus nozzle plate y-axis for a laser ablation masking process according to a second embodiment of the disclosure;

FIG. 11 is a two-dimensional graph of opacity curves versus nozzle plate y-axis for a laser ablation masking process according to a third embodiment of the disclosure;

FIG. 12 is a schematic view of a laser ablation system for ablating substrates according to another embodiment of the disclosure;

FIG. 13 is two-dimensional graph of flow feature depth versus nozzle plate y-axis for a prior art laser ablation process;

FIG. 14 is two-dimensional graph of flow feature depth versus nozzle plate y-axis for a laser ablation masking process according to a fourth embodiment of the disclosure; and

FIG. 15 is two-dimensional graph of flow feature depth versus nozzle plate y-axis for a laser ablation masking process according to a fifth embodiment of the disclosure.

### DETAILED DESCRIPTION OF EXEMPLARY EMBODIMENTS

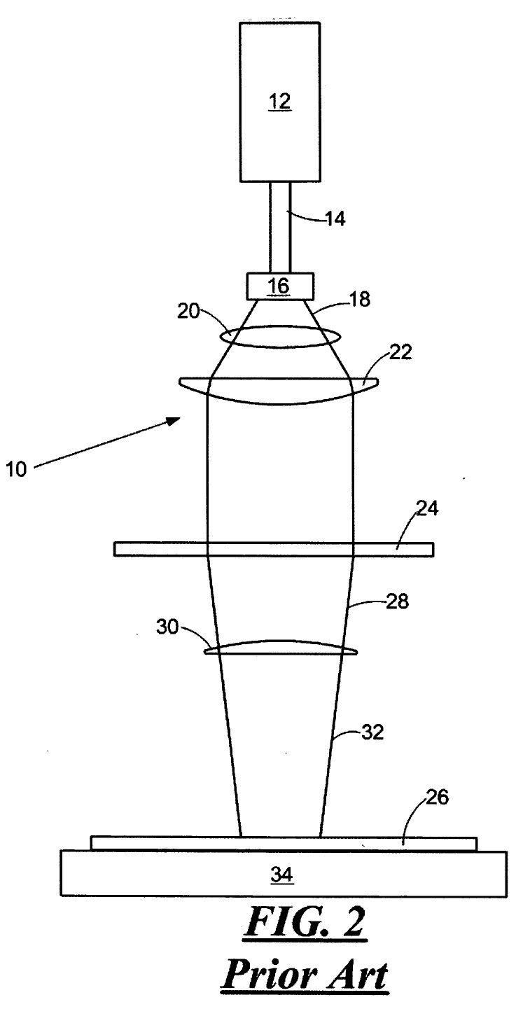

Laser ablation of materials for micro-miniature devices such as micro-fluid ejection heads is an efficient process for forming multiple ablated features in a substrate. A conventional laser ablation system 10 is illustrated schematically in FIG. 2. According to the system 10, an excimer laser 12 generates a coherent light beam that travels down a telescope section 14. Within the telescope section 14 are two lenses (not shown) which change the shape and focus of the coherent light beam. The coherent light beam is then expanded into individual light beams and then recombined by a homogenizer 16.

The homogenized coherent light beam 18 is then further focused by a condenser lens 20 and field lens 22 and is directed upon and through a mask 24. The mask 24 is made of a transparent material such as quartz and typically coated on one side with a light reflecting material such as chrome or a dielectric layer to provide transparent and opaque areas for forming laser ablated features in a substrate 26.

A portion 28 of the coherent light beam 18 emitted by laser 12 passes through the transparent portion of the mask 24 while the opaque portions of the mask 24 reflect other portions of the coherent light beam 18. The portion 28 of the coherent light beam 28 passing through the mask 24 is further reduced by a factor of five times by a reduction lens 30 to provide a reduced beam 32.

As is appreciated by a person of ordinary skill in the art the amount of reduction by the reduction lens 30 may vary depending on the size of features desired and the quality of the lenses 30 that are available. The reduced coherent light beam 32 is used to ablate the substrate 26 and form structures and features of a desired size and shape in the substrate 26. During the ablation process, the substrate 26 is typically supported on a platen 34.

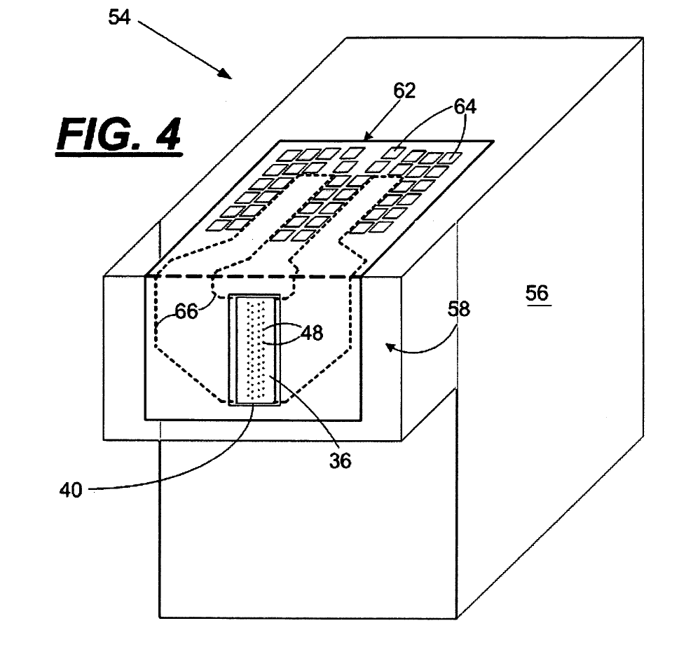

Laser ablation as described above may be used to form a plurality of features in the substrate 26. An example of the use of laser ablation is for the provision of a nozzle plate 36 for a micro-fluid ejection head 40. A portion of a micro-fluid ejection head 40 is illustrated in FIG. 3. The micro-fluid ejection head 40 includes a semiconductor substrate 42 containing a plurality of layers 44 providing a fluid ejection actuator 46. In the embodiment illustrate in FIG. 3, the ejection actuator 46 is a heater resistor. However, the disclosure is not intended to be limited to any particular ejection actuator or to micro-fluid ejection heads.

The nozzle plate 36 is attached to the substrate 42 and layers 44 to provide the micro-fluid ejection head 40. As shown, the nozzle plate 36 has formed therein, as by laser ablation, nozzle holes 48, a fluid chamber 50, and a fluid flow channel 52. The fluid chamber 50 and fluid flow channel 52 are collectively referred to herein as “flow features.” Fluid flowing through the fluid flow channel 52 to the fluid chamber 50 is heated by the ejection actuator 46 to provide a vapor bubble that forces fluid through the nozzle hole 48 and onto a fluid receptive medium. In another embodiment, a nozzle plate may contain nozzle holes only, and a separate thick film layer, attached to the substrate 42 provides the fluid chambers 50 and fluid flow channels 52.

In one embodiment, the micro-fluid ejection head 40 may be attached to a fluid cartridge 54 as shown in FIG. 4. The fluid cartridge 54 may include a fluid reservoir body 56 and a micro-fluid ejection head portion 58 for supply of fluid from the body 56 to the ejection head 40. As shown, the nozzle plate 36 for the micro-fluid ejection head 40 includes a plurality of nozzle holes 48 in one or more substantially linear arrays of nozzle holes 48.

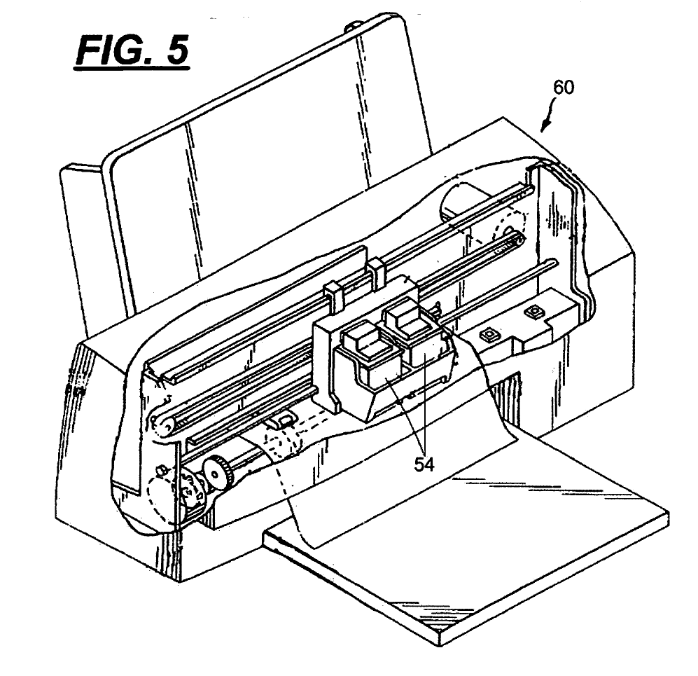

Activation of the ejection actuators 46 on the micro-fluid ejection head 40 is controlled by a ejection control device. In the case of a micro-fluid ejection head 40 for ejecting ink, an ink jet printer 60 (FIG. 5) may provide a suitable control device. Electrical contact between the ejection head 40 and printer 60 is provided by a tape automated bonding (TAB) circuit or flexible circuit 62 containing contact pads 64 for electrical connection to the control device. The contact pads 64 on the flexible circuit 62 are in electrical communication with the ejection head 40 as by conductive traces 66.

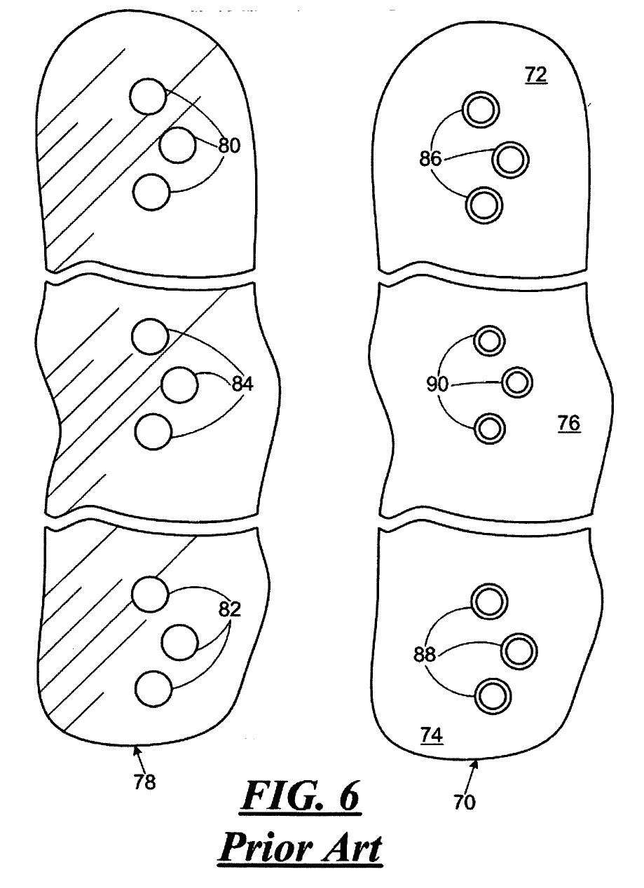

In the conventional laser ablation system 10 illustrated in FIG. 2, there are typically variations in ablated features from a first end of the nozzle plate 36 to a second end of the nozzle plate 36 along a length of the nozzle plate 36. A portion of a prior art nozzle plate 70 having a first end portion 72, a second end portion 74, and middle portion 76 is illustrated in FIG. 6. A corresponding mask 78 for laser ablating features in the nozzle plate 70 is also illustrated in FIG. 6. The mask contains transparent openings 80, 82, and 84 for forming nozzle holes 86, 88, and 90 respectively in the nozzle plate 70. Due to variations in reduced coherent beam 32 (FIG. 2) described above from the first end 72 to the second end 74 of the nozzle plate 70, nozzle holes 86 and 88 have larger diameters than nozzle holes 90 in a center portion 76 of the nozzle plate 70.

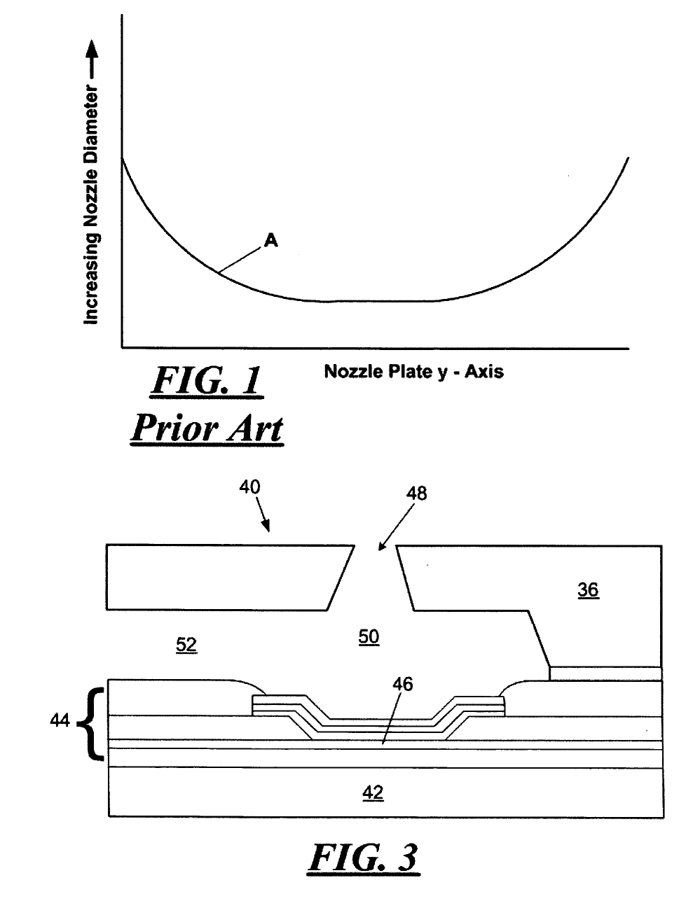

Typically laser ablation system 10 produces nozzle diameter variations of ±1 micron from the largest nozzles 86 and 88 to the smallest nozzle 90 as shown by curve A (FIG. 1). Without desiring to be bound by theory, it is believed that laser beam energy is lower for the nozzles 90 and higher for the nozzles 86 and 88 thereby increasing the wall angle of the nozzles 86 and 88, resulting in a larger exit diameter for nozzles 86 and 88.

In the case where flow channels, fluid chambers, and nozzles are ablated in the nozzle plate material 70, the flow channels and fluid chambers adjacent the end portions 72 and 74 of the nozzle plate 70 are ablated more deeply than the flow channels and fluid chambers in the middle portion 76 of the nozzle plate 70. Such added depth adjacent the end portions 72 and 74 may cause the nozzles 86 and 88 to be larger than the nozzles 90 even if all of the nozzles 86, 88, and 90 were ablated with substantially the same wall angles.

For the sake of simplicity so far in our discussion, the mask 78 and the nozzle plate 70 contain only a single row of nozzle holes. However, in a typical micro-fluid ejection head nozzle plate 70 at least two, and often more, rows of nozzle holes exist. Where a plurality of rows of nozzle holes are ablated simultaneously, consideration must be given to variations in diameter sizes of nozzle holes from one row to another. As would be appreciated by a person of ordinary skill in the art, similar variations can be anticipated along the width of a rectangular coherent light beam as well as along the length of the beam as discussed above. The method for correcting such variations in energy output discussed in the embodiments of the disclosure may be employed for any number of rows of nozzle holes and flow features formed in a nozzle plate or other substrate.

One method used to correct the foregoing problem is described, for example, in U.S. Pat. No. 6,089,959 to Komplin, the disclosure of which is incorporated by reference. In the method described in the '959 patent, a modified mask 24 is constructed having adjusted feature dimensions to compensate for laser beam energy variations from one end portion 72 to a second end portion 74 of the nozzle plate 70. Actual nozzle plate 70 feature dimensions are used to determine how the mask is to be modified to compensate for laser beam energy variations.

While the foregoing method is effective to compensate for a particular laser beam energy profile, other laser beam energy profiles may exist which require numerous variations of mask 24. It has been observed that the energy profile may change so often that it may not be feasible to provide all of the masks 24 required to provide uniform feature ablation during a manufacturing process.

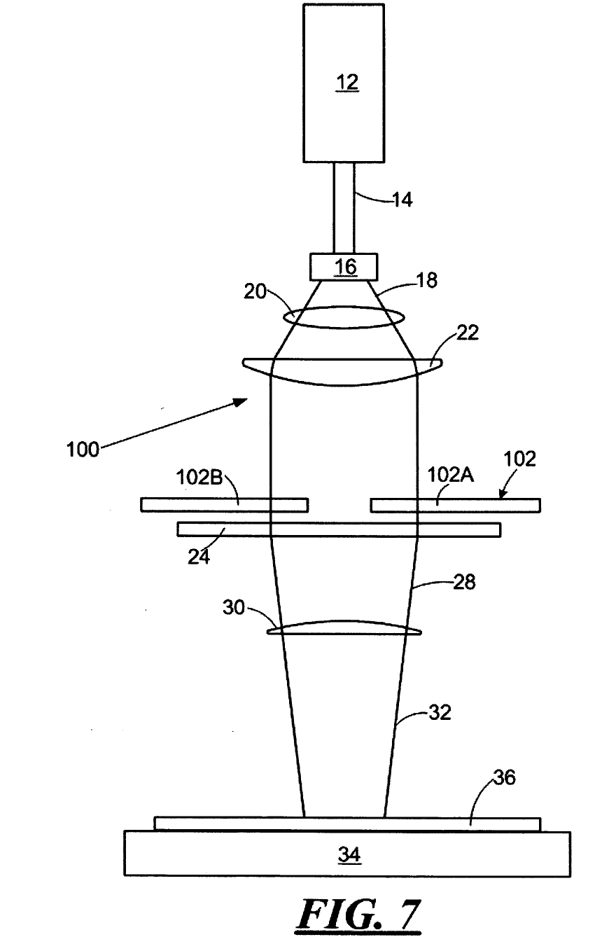

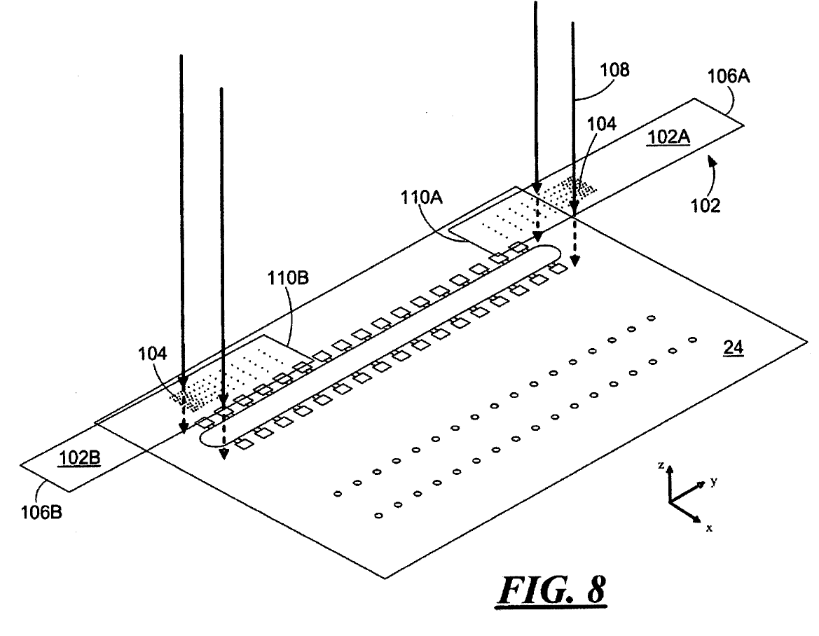

Hence, an adjustable method of laser beam energy compensation is provided by embodiments of the disclosure. Referring to FIG. 7, a modified laser ablation system 100 includes an adjustable gray scale mask 102 including mask portions 102A and 102B. The adjustable gray scale mask 102 is disposed between the condenser lens 20 and the reduction lens 30 and may preferably be disposed adjacent the primary mask 24 for attenuation of the laser beam energy. In one embodiment, illustrated in FIG. 8, the mask portions 102A and 102B include gray scale patterns 104, which may consist of chrome squares smaller in size than the resolution of the laser system 100 imaging optics. However, any shape of gray scale patterns 104 may be sufficient to attenuate the laser beam energy.

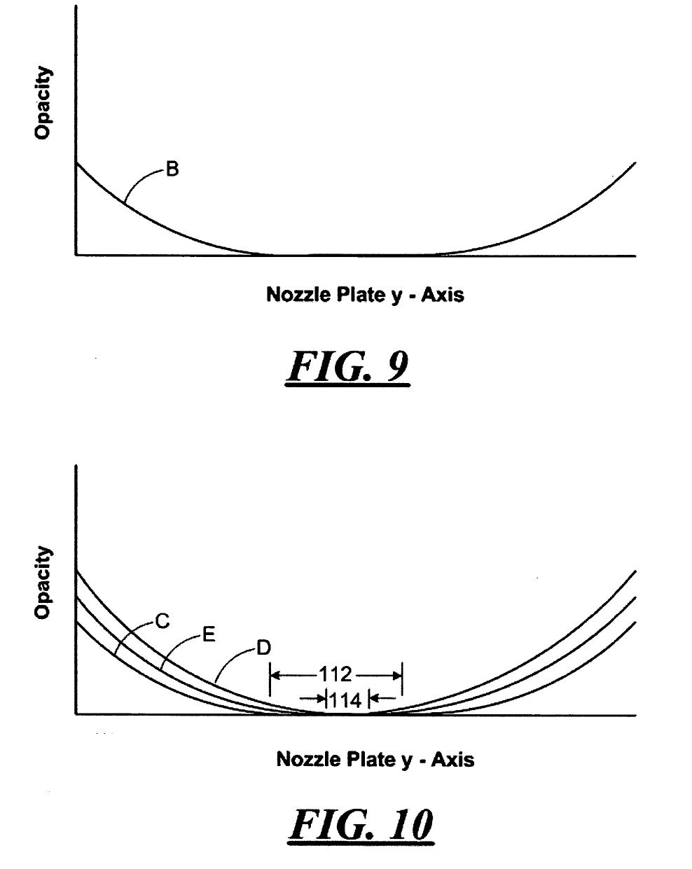

As shown in FIG. 8, the number or size of the gray scale patterns 104 increases toward a distal ends 106A, 106B of the mask 102 thereby providing increased opacity of the mask 102 toward the distal ends thereof. Curve B in FIG. 9 provides a plot of mask 102 opacity as a function of a nozzle plate y-axis which may provide ablated features for the nozzle plate 36 where the ablated features, for example nozzles holes 48, may otherwise have a nozzle diameter profile as shown in FIG. 1 in the absence of mask 102.

The gray scale patterns 104 of mask 102 may be effective to reflect a portion of the incoming laser beam 108, thus reducing the laser beam energy at distal ends of the mask 24 along a y-axis of the mask 24. Mask 102 may thus be effective to equalize the laser energy profile across the length and width of the beam 108 thereby equalizing the ablated features made in the nozzle plate 36.

During a laser ablation process, mask portions 102A and 102B are adjustable in the y direction by motorized or micrometer mount for example. Moving mask portions 102A and 102B toward or away from each other may be used to modify the energy profile of the beam 108 by modifying the opacity profile of the mask 102. One or both of the mask portions 102A and/or 102B may be moved to compensate for any particular laser beam energy profile. The mask portions 102A and 102B may be moved to a set position for the energy profile of the laser beam 108, or may be continuously movable during the laser ablation process.

The mask 102 shown in FIG. 8 is only slightly greater in width than the laser beam 108, e.g., about 6.5 millimeters wider than the laser beam 108. A standard square mask 102 of approximately 10 to 15 centimeters may be used. Accordingly, with a 10 to 15 centimeter square mask 102, several gray scale patterns, varying in opacity, may also be placed on the mask 102 in the x-axis direction (FIG. 8). Such a mask 102 may allow handling ablated features having different feature dimension profiles. In terms of the mask 102, the following terms are defined:

a) “inboard mask edge” is defined as the edge 110A or 110B of the mask portion 102A or 102B closest to the central x-axis of the beam 108.

b) “outboard mask edge” is defined as the distal edge 106A or 106B of the mask portion 102A or 102B that is furthest from the central x-axis of the beam 108.

c) “opacity gradient” is defined as the change in opacity from the inboard edge 110A or 110B to the outboard edge 106A or 106B of the mask portion 102A or 102B. Accordingly, a positive opacity gradient refers to a mask 102 having a zero opacity at the inboard edge 110A or 110B, and some opacity greater than zero at the outboard edge 106A or 106B. A negative opacity gradient may have a zero opacity gradient at the outboard edge 106A or 106B and some opacity greater than zero at the inboard edge 110A or 110B. A linear opacity gradient may have similar opacity moving from the inboard edge 110A or 110B to the outboard edge 106A or 106B.

In order to handle ablated features having dimension profiles of different magnitudes, several opacity gradients may be provided on each mask portion 102A or 102B. For the purposes of illustration only, the ablated feature profiles are nozzle hole 48 exit diameters in the nozzle plate 36. In other embodiments, the ablated feature formed in the nozzle plate 36 may be flow features such as fluid chambers 50 and flow channels 52.

In the alternate embodiments, mask 102 may include mask portions 102A or 102B having a positive opacity gradient, a negative opacity gradient, and a linear opacity gradient. Such mask portions 102A or 102B may be movable in both the y-axis direction and in the x-axis direction by either micrometer or motorized mount in order to select the desired opacity gradient.

For a mask 102 having a dimension of 10 to 15 centimeters square, the number of opacity gradients that may be provided on the mask 102 is limited. Accordingly, it may be desirable to change the opacity curve B (FIG. 9) without moving the mask 102 to a different opacity gradient position. One way to do achieve uniform nozzle hole 48 diameters in a nozzle plate 36 is illustrated graphically in FIG. 10 wherein a mask 102 having a single opacity gradient is used. Before ablating the nozzle holes 48 in the nozzle plate 36, the mask portions 102A and 102B may be moved apart so that the gray scale patterns 104 in the mask portions 102A and 102B are beyond outer limits of the laser beam 108 in the y-axis direction. Such a mask position provides an opacity profile that is illustrated graphically in FIG. 10 as curve C. Opacity profile C has a relatively wide flat area 112.

In an alternative process, the inboard edges 110A and 110B may be moved closer together to provide an opacity profile illustrated graphically in FIG. 10 as curve D for ablating nozzle holes 48 in the nozzle plate 36. Such an opacity profile (curve D) has a relatively narrow flat area 114.

In yet another alternative process, nozzle holes 48 in the nozzle plate 36 may be ablated for a portion of a depth of the nozzle holes 48 with the mask portions 102A and 102B at the position that provides the opacity profile of curve C. During ablation of the remaining depth of the nozzle holes 48 through the nozzle plate 36, the mask portions 102A and 102B may be moved together to the position that provides the opacity profile of curve D thereby providing a hybrid opacity profile illustrated graphically as curve E. The hybrid opacity profile (curve E) provides a unique opacity profile that cannot be readily obtained using a stationary mask technique for curves C and D. The resulting opacity profile curve E is an average of the opacity profiles of curve C and curve D. Switching from opacity curve C to opacity curve D at times other than half way through the ablation process may be effective to provide other opacity profile curves. It will be appreciated that the foregoing embodiment may also be applied to flow features such as fluid chambers 50 and flow channels 52 (FIG. 3) ablated in the nozzle plate 36.

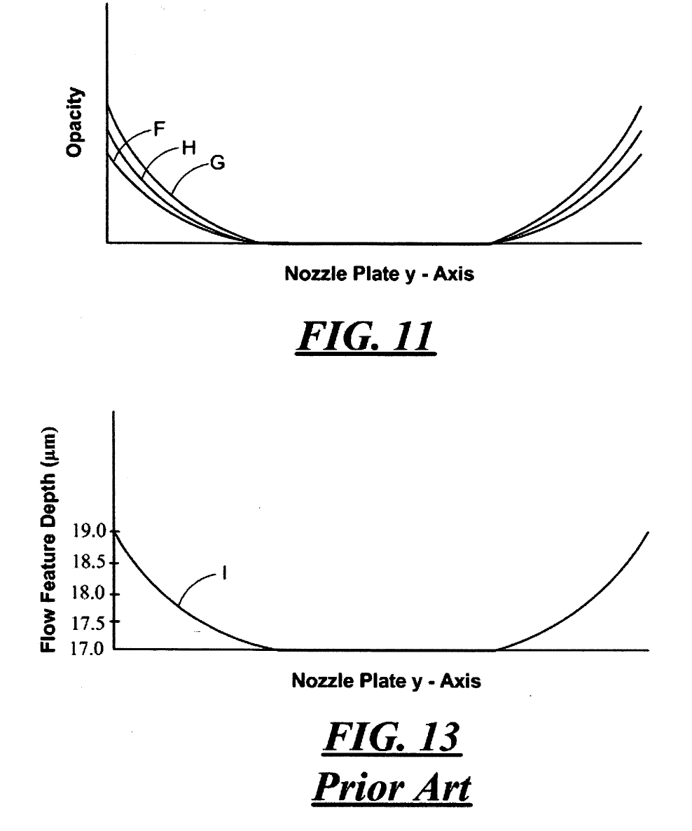

Another method for adjusting the opacity curve for a laser ablation system using a limited number of mask positions is illustrated and described with reference to FIG. 11. In the embodiment illustrated in FIG. 11, mask 102 contains multiple gray scale patterns 104 providing multiple opacity gradients. In this embodiment, a first mask position has a standard opacity gradient illustrated by opacity curve F in FIG. 11. A second mask position has a different opacity gradient illustrated by opacity curve G in FIG. 11. During an ablation process for forming nozzle holes 48 through a thickness of the nozzle plate 36, the mask portions 102A and 102B are placed in first mask position for ablating a portion of the depth of the nozzle holes through the nozzle plate 36. The mask is then moved in the x-axis direction to the second mask position to complete forming the nozzle holes 48 through the thickness of the nozzle plate 36. The resulting opacity gradient curve H is an average of the gradient curves F and G for the first and second positions in the x-axis direction of the mask portions 102A and 102B. Accordingly, using a mask 102 containing the first and second opacity gradients may be used for providing a variety of average opacity gradients depending on the depth of ablation used for each of the mask positions. A 10 to 15 centimeter square mask 102 may contain up to ten to 12 different gray scale patterns 104 providing different opacity gradients. Accordingly, the foregoing embodiments may include the combination of more than two different gray scale patterns 104 during the ablation process.

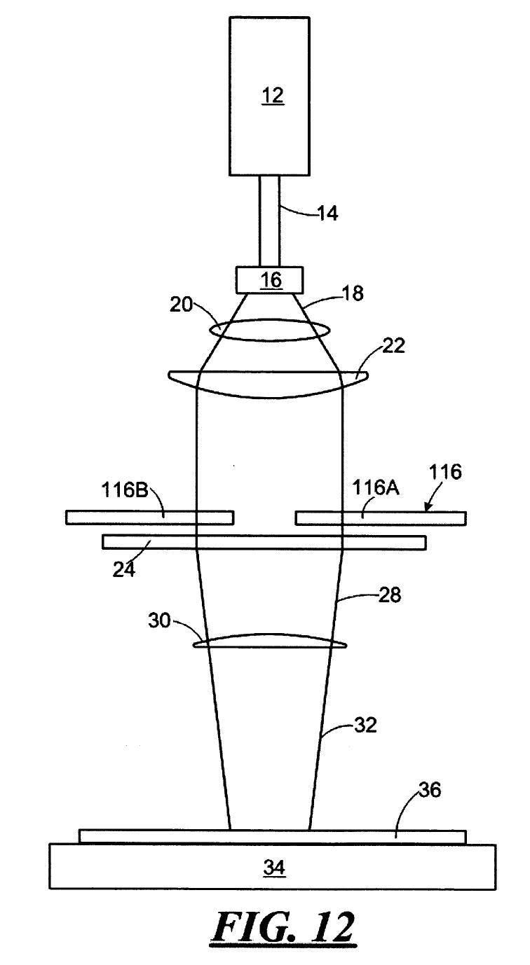

Yet another embodiment of the disclosure will now be described with reference to FIGS. 12-14. Instead of mask portions 102A and 102b, opaque objects 116A and 116B are placed in the path of the laser beam 108 (FIG. 12) during later stages of the ablation process. As described above, flow features such as fluid chambers 50 and fluid channels 52 have an ablation profile for the depth of the feature ablated in the nozzle plate 36 that is similar to the ablation profile for nozzle holes illustrated by curve A in FIG. 1 along the y-axis of the nozzle plate 36. The flow feature depth profile for a prior art ablation process is illustrated in FIG. 13 by curve I. Accordingly, end portions of the nozzle plate 36 may have a depth that ranges from about 1-2 μm greater than center portions of the nozzle plate 36 for an overall ablated depth of 17 microns.

During the laser ablation process for ablating flow features in a polyimide nozzle plate 36, each laser pulse may ablate the material to a depth of about 0.2 μm, thereby requiring about ten ablation pulses to ablate a depth of 2 μm. In order to equalize the ablation depth of the nozzle plate from one end to the other and avoid the depth variation illustrated in FIG. 13, opaque objects 116A and 116B may moved into the outer edges of the beam 108 when there are about ten ablation pulses remaining. The opaque objects 116A and 116B are effective to limit ablation of the nozzle plate material where the depth of the features would otherwise be about 2 μm greater than the depth of the features in the center portions of the nozzle plate 36 as shown by curve I (FIG. 13).

With nine ablation pulses remaining for ablating the flow features, the opaque objects 116A and 116B are moved toward each other in the outer edges of the beam 108 to limit ablation of the nozzle plate where the depth of the features would otherwise be about 1.8 μm greater than the depth of the features in the center portions of the nozzle plate 36 as shown by curve I (FIG. 13). The foregoing procedure of moving the opaque objects in the outer edges of the laser beam 108 are continued until only one ablation pulse remains. At that point, the opaque objects 116A and 116B are close enough to each other to block the beam 108 where the depth of the features would otherwise be more than about 0.2 μm greater than the depth of the features in the center portions of the nozzle plate 36 as shown by curve I (FIG. 13).

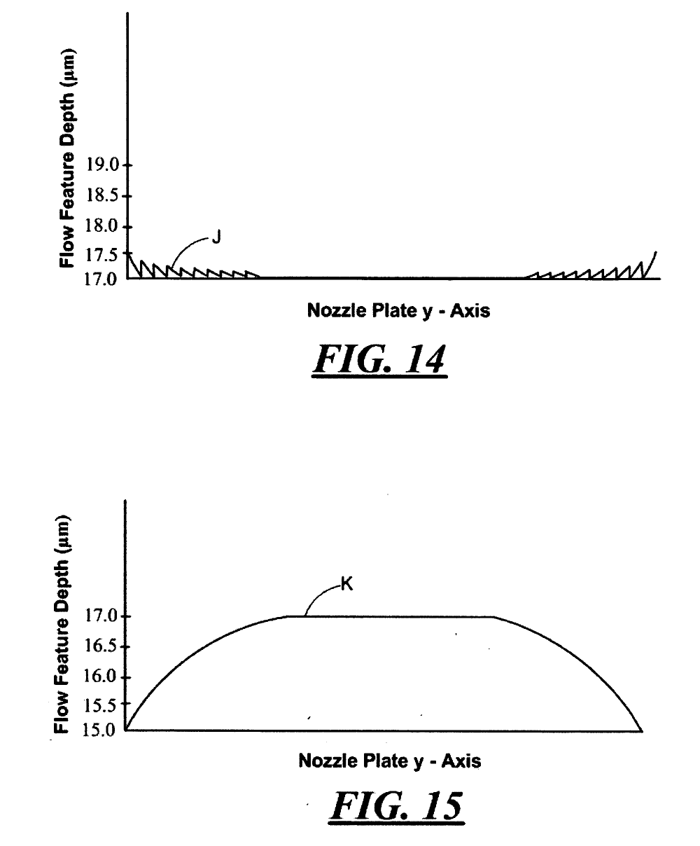

A resulting flow feature depth profile provided by the foregoing process is illustrated graphically in FIG. 14. In FIG. 14, curve J represents the ablation depth profile of the features obtained by moving an opaque object into the outer edges of the beam 18 during later stages of the laser ablation process. According, the method provides a more uniform flow feature depth across a flow feature array in the y-axis direction of the nozzle plate 36. It will be appreciated that different depth profiles may require different movement of the opaque objects 116A and 116B to achieve a profile generally as shown by curve J (FIG. 14).

The foregoing process using opaque objects 116A and 116B may also be used to provide uniform nozzle hole exit diameters in the nozzle plate 36 material along a nozzle hole array in the y-axis of the nozzle plate. Again, using FIG. 13 for reference as an illustration of the depth profile for nozzle holes made by a prior art laser ablation process, the opaque objects 116A and 116B are moved into the outer edges of the beam 108 when there are about 10 laser ablation pulses remaining so that nozzle holes toward the outer edges of the nozzle plate 36 along the y-axis are exposed to fewer laser pulses. Reducing the number of pulses for the outer portions of the nozzle plate is effective to reduce the wall angles of such nozzle holes thereby reducing the exit hole diameters so that the exit hole diameters are substantially the same as the exit hole diameters in center portions of the nozzle plate 36. Otherwise, outer edges of the laser beam 108, having more energy than inner portions of the beam 108 would ablate the nozzle holes to a greater depth toward the outer edges of the nozzle plate 36 thereby increasing the wall angle of the nozzle holes.

In a further embodiment, nozzle holes 48 having uniform exit diameters along the nozzle plate 36 y-axis from one end of the nozzle plate 36 to the other end of the nozzle plate 36 may be made without providing flow features such as fluid chambers 50 and flow channels 52 having a uniform depth profile. For example, the opaque objects 116 (FIG. 12) may be moved into the outer edges of the beam 108 with 20 pulses left. Hence, the ablation depth of the flow features toward the end portions of the nozzle plate 36 will be 2 μm less than the depth of the flow features in the center portion of the nozzle plate 36. Subsequently, with 18 pulses left the opaque objects 116 may be moved toward each other to a portion of the nozzle plate 36 where the depth of the flow features would have otherwise been 1.8 μm greater than the depth of the flow features in the center portion of the nozzle plate. The foregoing procedure is repeated until only two ablation pulses are left for ablating the flow features so that the opaque objects 116 are positioned where the ablation depth of the flow features would have otherwise been 0.2 μm greater than the depth of the flow features in the center portion of the nozzle plate 36. Accordingly, the depth profile for the flow features would be similar to K in FIG. 15.

After ablating the flow features, the nozzles 48 may be ablated through the remaining thickness of the nozzle plate 36 using conventional techniques such as a nozzle hole mask 78 (FIG. 6). The decreased ablation depth of the flow features toward the end portions of the nozzle plate 36 increases the remaining thickness through which the nozzles 48 are ablated in the end portions of the nozzle plate as compared to the center portions of the nozzle plate. Thus, the exit diameter of the nozzle holes 48 in the end portions of the nozzle plate would be reduced, thereby avoiding the non-uniform nozzle hole exit diameters described with respect to FIG. 6.

In a further modification, a uniform flow feature depth may be provided as shown in FIG. 14. Uniform nozzle exit diameters may then be provided by use of the gray scale mask 102 as described above.

It is contemplated, and will be apparent to those skilled in the art from the preceding description and the accompanying drawings, that modifications and changes may be made in the embodiments of the disclosure. Accordingly, it is expressly intended that the foregoing description and the accompanying drawings are illustrative of exemplary embodiments only, not limiting thereto, and that the true spirit and scope of the present disclosure be determined by reference to the appended claims.

What is claimed is:

1. A method of laser ablating a polymeric material for providing a nozzle plate for a micro-fluid ejection head, the method comprising:
laser ablating polymeric material using a first mask and a second mask in combination so that ablated flow features made in the polymeric material have substantially uniform flow feature dimensions, wherein the first mask is for laser ablating flow features in the polymeric material using a laser beam and the second mask is disposed in the laser beam for attenuating laser beam.

2. The method of claim 1, wherein the second mask includes gray scale features providing opacity gradation therein.

3. The method of claim 2, further comprising moving the second mask during the ablating step.

4. The method of claim 1, further comprising moving the second mask during the ablating step.

5. The method of claim 1, wherein the polymeric material is laser ablated to provide an array of nozzle holes therein.

6. The method of claim 5, wherein the polymeric material is laser ablated to provide fluid chambers and fluid flow channels therein.

7. The method of claim 1, wherein the flow feature dimensions comprise nozzle exit diameters.

8. The method of claim 1, wherein the flow feature dimensions comprise nozzle wall angles.

9. The method of claim 1, wherein the flow feature dimensions comprise fluid chamber wall angles.

10. A nozzle plate made by the method of claim 1.

11. A micro-fluid ejection head comprising the nozzle plate of claim 10.

12. A laser beam attenuation method for a laser ablation process, comprising:
moving a second mask relative to a first mask in a laser beam during a laser ablation process to provide substantially uniform laser beam energy distribution to the first mask whereby ablated features in a polymeric material are substantially uniform from a first end of the material to a second end of the material, wherein the first mask is disposed in the laser beam and contains ablation features therein for ablating the polymeric material and the second mask is disposed in the laser beam and contains opacity gradation features.

13. The method of claim 12, wherein the second mask comprises a plurality of opacity gradation features.

14. The method of claim 12, wherein the second mask comprises a first portion and a second portion wherein the first and second portions may be moved relative to one another, further comprising, moving the first and second portions in opposite directions along an axis during the laser ablation process.

15. The method of claim 12, wherein the second mask comprises a first portion and a second portion wherein the first and second portions may be moved relative to one another, further comprising, moving the first and second portions in opposite directions along an axis to a predetermined positions prior to the laser ablation process.

16. The method of claim 12, wherein the ablated features comprise an array of nozzle holes.

17. The method of claim 16, wherein the array of nozzle holes have substantially uniform exit diameters from the first end to the second end of the polymeric material.

18. The method of claim 16, wherein the array of nozzle holes have substantially uniform wall angles from the first end to the second end of the polymeric material.

19. The method of claim 16, wherein the ablated features comprise fluid chambers and fluid flow channels.

20. The method of claim 19, wherein the fluid chambers have substantially uniform wall angles and ablation depths from the first end to the second end of the polymeric material.

21. The method of claim 12, wherein the second mask is disposed adjacent the first mask.

22. A nozzle plate for a micro-fluid ejection head made by the method of claim 12.

23. A micro-fluid ejection head comprising the nozzle plate of claim 22.
